(19) United States
(12) Patent Application Publication
(10) Pub. No.: US 2015/0255793 A1
(43) Pub. Date: Sep. 10, 2015

(54) CARBON MATERIAL FOR NEGATIVE ELECTRODE FOR LITHIUM ION SECONDARY BATTERY, MANUFACTURING PROCESS THEREFOR AND USE THEREOF

(71) Applicant: SHOWA DENKO K.K., Minato-ku, Tokyo (JP)

(72) Inventors: Yasuaki Wakizaka, Tokyo (JP); Chiaki Sotowa, Tokyo (JP); Takashi Terashima, Tokyo (JP)

(73) Assignee: SHOWA DENKO K.K., Minato-ku, Tokyo (JP)

(21) Appl. No.: 14/431,398

(22) PCT Filed: Sep. 25, 2013
(86) PCT No.: PCT/JP2013/005685

§ 371 Date: Mar. 26, 2015

(30) Foreign Application Priority Data
Sep. 27, 2012 (JP) 2012-214787
Mar. 8, 2013 (JP) 2013-047361

(51) Int. Cl. H01M 4/587; H01M 10/0525; B29C 43/00; C01B 31/04

(52) U.S. Cl. CPC H01M 4/587; C01B 31/04; H01M 10/0525; B29C 43/003; H01M 2004/021

(57) ABSTRACT

A carbon material for negative electrodes in lithium ion secondary battery, wherein a specific surface area is not less than 1.5 m²/g and not more than 6.5 m²/g, a tap density is not less than 0.5 g/cm³ and not more than 1.3 g/cm³, a Raman R value is not less than 0.1 and not more than 0.4, no diffraction peak is present in a range of diffraction angle of 42.7° to 43.7° in X-ray diffraction analysis, d₀₀₂ is not more than 0.337 nm, and at most one peak is present in a range of not less than 500° C. and less than 1000° C. in thermogravimetric-differential thermal analysis.

### TECHNICAL FIELD

The present invention relates to a carbon material for negative electrode in lithium ion secondary battery, a manufacturing process therefor and a use thereof. More specifically, the present invention relates to a carbon material useful as a negative electrode active material with which lithium ion secondary battery having a high initial efficiency, a high discharge capacity and superior cycle characteristics can be obtained, and also relates to a manufacturing process therefor and a use thereof.

### BACKGROUND ART

Lithium ion secondary batteries are used as power supplies of portable electronic devices. Meanwhile, the functions of portable electronic devices have been diversified, and the power consumption thereof has increased. Therefore, there is a demand for further increasing a capacity of lithium ion secondary batteries. Further, lithium ion secondary batteries are also used as power supplies for power tools, electric vehicles and the like. In electric vehicles such as battery electric vehicles (BEV), hybrid electric vehicles (HEV) and the like, the followings are required: the high charge and discharge cycle characteristics are maintained for 10 years or more; the large current load characteristics are sufficiently high to drive a high power motor; and the volumetric energy density is high to increase cruising distance.

Various carbon materials are used as negative electrode active materials for lithium ion secondary batteries. In a case where graphite is used as a negative electrode active material, a lithium ion secondary battery with a high capacity can be obtained. However, in the case of a common graphite, undesired reactions with an electrolytic solution often occur since an edge into which lithium ions can be intercalated is exposed on a surface. Therefore, the resulting lithium ion secondary battery tends not to have a high initial efficiency.

Accordingly, improving battery characteristics by the surface modification of graphite has been attempted. The coating method and the rounding method are known as approaches for surface modification.

The coating method involves mixing a pitch or a resin with graphite in a liquid phase or a solid phase, and then performing graphitization or carbonization to cover an edge present on the surface of the graphite.

The rounding method involves performing mechanical rounding treatment on graphite to cover and crush an edge on a surface (see Patent Documents 1 to 4). Further, an approach comprising performing mechanical rounding treatment on a low crystallinity carbon raw material and then performing graphitization also has been proposed (see Patent Documents 5 or 6).

### CITATION LIST

### Patent Literature

### Patent Document 1: JP 4870419 B

### Patent Document 2: JP H11-45715 A

### Patent Document 3: JP 3916012 B

### Patent Document 4: JP 2003-132889 A

### Patent Document 5: JP 2003-171110 A

### Patent Document 6: JP 2011-216231 A

### SUMMARY OF THE INVENTION

### Problems to be Resolved by the Invention

Since an amorphous layer is formed on a surface when carbonization is performed in the coating method, the crushability and the capacity retention ratio at high temperature tend to be decreased. Since an edge is newly formed on a surface of a coating material when graphitization is performed in the coating method, the initial efficiency may not be sufficiently improved.

Meanwhile, the crystalline form of graphite may change from hexagonal to rhombohedral by the rounding treatment. Since rhombohedral crystal is inferior in terms of the reversibility in a intercalation and deintercalation reaction of lithium ions, the charge and discharge characteristics of a battery tend to deteriorate. Even a method comprising performing mechanical rounding treatment on a low crystallinity carbon raw material, and then performing graphitization has failed to deliver satisfactory results.

An object of the present invention is to provide a carbon material useful as a negative electrode active material with which a lithium ion secondary battery having a high initial efficiency, a high discharge capacity and superior cycle characteristics can be obtained, and to provide a manufacturing method therefor and a use thereof.

### Means for Solving the Problems

After conducting extensive studies to achieve the above objects, the present inventors have completed an invention including the following embodiments.

[1] A carbon material for negative electrode in lithium ion secondary battery, wherein a specific surface area is not less than 1.5 m²/g and not more than 6.5 m²/g, a tap density is not less than 0.5 g/cm³ and not more than 1.3 g/cm³, a Raman R value is not less than 0.1 and not more than 0.4, no diffraction peak is present in a range of diffraction angle of 42.7° to 43.7° in X-ray diffraction analysis, d₀₀₂ is not more than 0.337 nm, and at most one peak is present in a range of not less than 500° C. and less than 1000° C. in thermogravimetric-differential thermal analysis.
[2] The carbon material according to [1], wherein a 50% particle diameter (D50) in a volumetric cumulative particle size distribution by the laser diffraction method is not less than 1 μm and not more than 50 μm.
[3] The carbon material according to [1] or [2], which provides a battery comprising a negative electrode, the negative electrode comprising a formed layer wherein the ratio T500/T10 of the thickness T500 of the formed layer at the end of discharge in the 500th cycle when 500 cycles of charge-discharge are performed at 1 C to the thickness T10 of the formed layer at the end of discharge in the 10th cycle when 10 cycles of charge-discharge are performed at 1 C is not less than 1.0 and not more than 1.30.
[4] A method for manufacturing the carbon material according to any one of [1] to [3], the method comprising applying impact compression force to a granular graphite using a mechanical rotary machine to perform surface modification.
[5] The method for manufacturing the carbon material according to [4], wherein the ratio of an apparent density after performing the surface modification to an apparent density before performing the surface modification is less than 1.1.
[6] The method for manufacturing the carbon material according to [4] or [5], wherein the granular graphite is an artificial graphite subjected to heat treatment at a temperature of not less than 2400° C. and not more than 3600° C.
[7] The method for manufacturing the carbon material according to any one of [4] to [6], wherein the granular graphite is an artificial graphite synthesized from coke or pitch.
[8] The method for manufacturing the carbon material according to any one of [4] to [6], wherein the granular graphite is an artificial graphite synthesized by heat treating particles obtained by pulverizing calcined coke.
[9] A paste for electrode, wherein the paste comprises the carbon material according to any one of [1] to [3] and a binder.
[10] An electrode comprising a formed layer, wherein the formed layer comprises the carbon material according to any one of aforementioned [1] to [3] and a binder.
[11] An electrode comprising a formed layer, wherein the ratio T500/T10 of the thickness T500 of the formed layer at the end of discharge in the 500th cycle when 500 cycles of charge-discharge are performed at 1 C to the thickness T10 of the formed layer at the end of discharge in the 10th cycle when 10 cycles of charge-discharge are performed at 1 C is not less than 1.0 and not more than 1.30.
[12] A battery comprising the electrode according to [10] or [11].

### Advantageous Effects of the Invention

The carbon material for negative electrode in lithium ion secondary battery according to the present invention has neither an edge on a surface causing a side reaction with an electrolytic solution nor rhombohedral crystal. Therefore, a lithium ion secondary battery having a high initial efficiency, a high discharge capacity and superior cycle characteristics can be obtained.

In the manufacturing method according to the present invention, surface modification treatment can be performed on an artificial graphite in which pitch coke, needle coke and the like are used as raw materials, without causing the transformation from hexagonal crystal to rhombohedral crystal.

The lithium ion secondary battery according to the present invention, which has a high initial efficiency, a high discharge capacity and superior cycle characteristics, can be used as a power supply for an electronic device such as a cellular phone, a notebook or tablet PC, a digital camera and the like; a high power device such as a power tool, a battery-assisted bicycle, an aircraft and the like.

### BRIEF DESCRIPTION OF THE DRAWINGS

FIG. 1 shows a scanning electron microscope photograph image of the carbon material for negative electrode in lithium ion secondary battery according to one embodiment of the present invention.

### EMBODIMENTS FOR CARRYING OUT THE INVENTION

The carbon material for negative electrode in lithium ion secondary battery according to one embodiment of the present invention (hereinafter may simply be referred to as a “carbon material”) will be described.

The carbon material according to one embodiment of the present invention has a specific surface area of usually not less than 1.5 m²/g and not more than 6.5 m²/g, preferably not less than 1.5 m²/g and not more than 5 m²/g, more preferably not less than 1.5 m²/g and not more than 4 m²/g, even more preferably not less than 1.5 m²/g and not more than 3 m²/g. The specific surface area is computed by the BET method based on nitrogen adsorption. Measurement instruments include, for example, NOVA-4200e (QUANTANCHROME INSTRUMENTS Co.). In a case where the specific surface area is too large, a side reaction with an electrolytic solution tends to occur easily, resulting in a decreased initial efficiency. In a case where the specific surface area is too small, a contact area with an electrolytic solution is reduced, and the intercalation of lithium ions tends to be difficult to progress smoothly, resulting in degraced cycle characteristics and the like.

The carbon material according to one embodiment of the present invention has a tap density of usually not less than 0.5 g/cm³ and not more than 1.3 g/cm³, preferably not less than 0.8 g/cm³ and not more than 1.3 g/cm³, more preferably not less than 0.85 g/cm³ and not more than 1.3 g/cm³. The tap density refers to an apparent density as measured after filling a predetermined container with a carbon material and then performing tapping for 400 times. In a case where the tap density is too low, the density (electrode density) of a formed layer comprising a carbon material and a binder comprised in an electrode tends to easily become low, and a charge and discharge capacity tends to be decreased. In a case where the tap density is too high, voids in the formed layer comprising a carbon material and a binder become fewer, and the electric conductivity of the formed layer tends to be decreased.

The carbon material according to one embodiment of the present invention has a Raman R value of usually not less than 0.1 and not more than 0.4, preferably not less than 0.1 and not more than 0.3, more preferably not less than 0.1 and not more than 0.2. The Raman R value refers to the ratio I_{D}/I_{G} of the intensity I_{D} of a peak present in a range of 1350 cm⁻¹ to 1370 cm⁻¹ to the intensity I_{G} of a peak present in a range of 1570 cm⁻¹ to 1630 cm⁻¹ in Raman spectroscopy measurements with argon ion laser at a wavelength of 514.5 nm. In a case where the R value is too low, edges involved in intercalation or deintercalation of lithium ions are too few, and battery characteristics tend to be decreased. In a case where the R value is too high, a side reaction tends to easily occur at charge and discharge.

Meanwhile, graphites include a hexagonal crystal graphite or a rhombohedral crystal graphite. A hexagonal crystal graphite shows diffraction peaks (a hexagonal crystal 100 diffraction line and a hexagonal crystal 101 diffraction line) that appear in a range of diffraction angle of 41.7° to 42.7° and a range of 43.7° to 44.7°. A rhombohedral crystal graphite shows diffraction peaks (a rhombohedral crystal 101 diffraction line and a rhombohedral crystal 012 diffraction line) that appear in a range of diffraction angle of 42.7° to 43.7° and a range of 45.5° to 46.5°. Therefore, a graphite may show 2 or 4 diffraction peaks in a range of diffraction angle (2θ, θ: Bragg angle) of 40° to 50°.

Note that a hexagonal crystal graphite has a so-called AB layered structure in which layers comprising a hexagonally networked planar structure of carbon are each stacked with a displacement of (⅔, ⅓). In contrast, a rhombohedral crystal graphite has a so-called ABC layered structure in which layers comprising a hexagonally networked planar structure of carbon are each stacked first with a displacement of (⅔, ⅓) and then with a displacement of (⅓, ⅔). The rhombohedral crystal structure may be formed due to lattice distortion introduced when a hexagonal crystal graphite is pulverized.

The carbon material according to one embodiment of the present invention shows no diffraction peak in a range of diffraction angle of 42.7° to 43.7° in X-ray diffraction analysis. In other words, in the carbon material according to one embodiment of the present invention, the ratio P2/(P1+P2) of the peak area P2 of the rhombohedral crystal 101 diffraction line to the sum of the peak area P1 of the hexagonal crystal 100 diffraction line and the peak area P2 of the rhombohedral crystal 101 diffraction line is 0. That is, the carbon material according to one embodiment of the present invention consists of only a hexagonal crystal graphite, and does not contain a rhombohedral crystal graphite. When such a carbon material is used, the intercalation of lithium ions into between carbon layers is smoothly facilitated, and a lithium ion secondary battery having superior rapid charge and discharge characteristics can be easily obtained.

The carbon material according to one embodiment of the present invention has a d₀₀₂ of usually not more than 0.337 nm, preferably not more than 0.3367 nm. In a case where d₀₀₂ falls in such a numerical value range, the amount of lithium ions which can be intercalated or deintercalated is increased, and the energy density per battery weight tends to be high.

Further, the carbon material according to one embodiment of the present invention has an L_{c} of preferably 20 nm to 1000 nm. In a case where L_{c} falls in such a numerical value range, the energy density per weight and the crushability tend to be good.

Note that d₀₀₂ and L_{c} are values as computed based on the 002 diffraction line in powder X-ray diffraction analysis.

The carbon material according to one embodiment of the present invention shows at most one peak in a region of not less than 500° C. and less than 1000° C. in thermogravimetric-differential thermal analysis. Further, the carbon material according to a preferred embodiment of the present invention shows no peak in a region of not less than 600° C. and not more than 800° C. and shows only one peak in a region of not less than 800° C. and less than 1000° C. in thermogravimetric-differential thermal analysis.

Measurements in thermogravimetric-differential thermal analysis (TG-DTA measurements) are performed under an air flow atmosphere. An exothermic decomposition peak in differential thermal analysis (DTA) shows a spread of a carbon skeleton structure. A higher temperature at which an exothermic decomposition peak appears indicates a higher crystallinity carbon material in which carbon skeleton structures are developed. In general, an amorphous carbon, in which carbon skeleton are not regularly arranged, has an exothermic peak observed in a region of not more than 800° C. A graphite in which carbon skeleton are highly developed has an exothermic peak observed in a region of not less than 800° C.

The carbon material according to a preferred embodiment of the present invention has a 50% particle diameter (D50) in a volumetric accumulative particle size distribution by the laser diffraction method of preferably not less than 1 μm and not more than 50 μm, more preferably not less than 5 μm and not more than 35 μm, even more preferably not less than 10 μm and not more than 25 μm. In order to obtain a carbon material with a small D50, a pulverizing equipment which can supply high energy is required. Further, fine powders, which have a large surface area, tend to facilitate an unexpected side reaction to occur. In a case where D50 is too large, properties at high-speed charge and discharge with a large current tends to deteriorate. When used as a power supply for an electric vehicle and the like, D50 is preferably not less than 10 μm and not more than 25 μm.

The carbon material according to a preferred embodiment of the present invention can provide a battery comprising a negative electrode, the negative electrode having a formed layer wherein the ratio T500/T10 of the thickness T500 of the formed layer at the end of discharge in the 500th cycle when 500 cycles of charge-discharge are performed at 1 C to the thickness T10 of the formed layer at the end of discharge in the 10th cycle when 10 cycles of charge-discharge are performed at 1 C is preferably not less than 1.0 and not more than 1.30, more preferably not less than 1.0 and not more than 1.20, even more preferably not less than 1.0 and not more than 1.10. The value of T500/T10 should not be less than 1.0 if there is not a measurement error. And a larger value of T500/T10 means that the irreversibility of charge and discharge reactions in a battery is larger. The ratio T500/T10 of the thicknesses falling within the above range is suitable for obtaining a long-life and large-sized battery in which the reversibility of charge and discharge reactions in the battery is high.

Note that the ratio T500/T10 of the formed layer thicknesses is determined as follows. First, a negative electrode comprising a formed layer is obtained by a method as described below using a carbon material. At least two batteries with the same specification are assembled using the negative electrode and a known positive electrode. For one of the above batteries, the thickness T10 of the formed layer in the negative electrode is measured at the end of discharge in the 10th cycle when 10 cycles of charge and discharge are performed at 1 C. Separately, for another one of the above batteries, the thickness T500 of a formed layer in the electrode for negative is measured at the end of discharge in the 500th cycle when 500 cycles of charge and discharge are performed at 1 C. The ratio T500/T10 is computed from the above measured values.

The method for manufacturing a carbon material according to the present invention comprises applying impact compression force to a granular graphite using a mechanical rotary machine to perform surface modification.

As a granular graphite, any one or both of a natural graphite and an artificial graphite can be used, but an artificial graphite is preferred. In the case of an artificial graphite, rhombohedral crystal is more difficult to be formed with impact force as compared with a natural graphite. Among artificial graphites, a granular graphite is preferably an artificial graphite synthesized using a raw material composed of a coke or a pitch.

A coke or a pitch may be derived from either petroleum or coal, but a petroleum-derived one is preferred.

In general, an artificial graphite can be obtained by performing the carbonization of a raw material and the graphitization of the resulting carbonized material. Carbonization is performed at usually less than 2400° C., preferably not less than 1000° C. and not more than 2000° C., more preferably not less than 1100° C. and not more than 1500° C. Graphitization is performed at usually not less than 2400° C., preferably not less than 2400° C. not more than 3600° C., more preferably not less than 2800° C. not more than 3200° C. Further, graphitization may be directly performed without subjected to a carbonization step. The carbonization and graphitization as described above are preferably performed under an inert atmosphere. Further, carbonization and graphitization can be performed in an Acheson graphitization furnace, an electromagnetic induction heating furnace or the like.

Graphitization may be performed under an inert atmosphere such as under argon. Moreover, when surface oxidization is performed by contacting with air during or after graphitization, more preferred properties such as an improved initial efficiency when used as a negative electrode active material, a high capacity retention ratio after prolonged charge and discharge cycles can be obtained.

Before or after carbonization or before or after graphitization, pulverization and/or classification may be performed to adjust to a desired particle size. In the present invention, it is preferred to perform pulverization and/or classification to adjust to a desired particle size after carbonization and before graphitization because the formation of rhombohedral crystal can be prevented. That is, in the present invention, the followings are preferred: a raw coke is heat-treated at a temperature of about 1300° C. to about 1400° C., and moisture and volatile matter are removed to obtain a calcined coke; the resulting calcined coke is pulverized into a predetermined size; and the resulting particles are heat-treated to perform graphitization.

A granular graphite as a raw material has a 50% particle diameter in a volumetric accumulative particle size distribution by the laser diffraction method of preferably not less than 1 μm not more than 50 μm, more preferably not less than 5 μm not more than 35 μm, even more preferably not less than 10 μm and not more than 25 μm. In a case where the amount of fine particles is large, the electrode density is difficult to be increased, and in a case where the amount of large particles is large, battery characteristics may deteriorate. A D50 of 10 μm or more is even more preferred because fine powder, which has a large surface area, may cause unintended reactions, and thus the amount of fine powder is preferred to be reduced. A D50 of 25 μm or less is preferred when used for applications such as drive power supplies for automobiles which require generation of a large current.

Surface modification in the manufacturing method according to the present invention is performed by applying impact compression force to a granular graphite using a mechanical rotary machine.

Impact compression force refers to compressive force applied to particles due to the collision with a rotary part and the subsequent collision between particles and with an inner wall of the equipment. Rhombohedral crystal tends to be formed when a granular graphite is crushed or lattice strain is introduced into a granular graphite by impact compression force. Therefore, in the manufacturing method according to the present invention, impact compression force is preferably applied without introducing strain into the crystalline structure of a graphite, and without significantly changing the particle diameter and crystalline structure. In the present invention, shearing force may be applied in addition to impact compression force.

With regards to preferred operating conditions of a mechanical rotary machine, the peripheral velocity (m/s) of a pulverizing rotor is set to preferably not less than 20 m/s not more than 200 m/s, more preferably not less than 50 m/s not more than 170 m/s. Note that the peripheral velocity can be calculated by: the radius of rotation (m)×2×the circular constant×the rotation rate (rpm)/60. There is no particular limitation for materials of which the rotor is made. They include, for example, steel, ceramics and the like.

The duration of surface modification treatment is preferably not less than 10 seconds not more than 90 minutes, more preferably not less than 10 seconds not more than 5 minutes. Further, the throughput of fine particles per batch is preferably not less than 1 kg not more than 100 kg.

Examples of mechanical rotary machines used to apply impact compression force include a kneader such as a pressure kneader, a two-roll kneader and the like; a high-speed impact dry composing machine such as a rotary ball mill, a hybridization system (registered trademark: NARA MACHINERY CO., LTD.) and the like; a compression shearing dry powder composing machine such as a Mechanomicro System (NARA MACHINERY CO., LTD.), a Mechanofusion System (registered trademark: HOSOKAWA MICRON CORP.), Nobilta (registered trademark: HOSOKAWA MICRON CORP.), and the like.

Further, examples of other mechanical rotary machines include a system (mechanofusion system) comprising at least a rotary drum and an inner piece rotating at a different peripheral velocity from the rotary drum, wherein while applying centrifugal force to a granular graphite fed into between the rotary drum and the inner piece, shearing force and compression force resulting from the velocity difference between the inner piece and the rotary drum can be simultaneously applied to the graphite to perform mechanochemical treatment; a system (hybridization system) comprising a fixed drum (stator) and a high speed rotary rotor, wherein by passing a granular graphite through between the stator and the rotor, shearing force and compression force resulting from the rotation of the rotor can be simultaneously applied to the graphite to perform mechanochemical treatment. Further, as a mechanical rotary machine, preferred is a system in which surface modification is performed by the collision of a graphite powder with a rotary drum or a rotor, and the collision between the graphite powders. As such spheronization processing systems, mentioned are, for example, ACM Pulverizer®, Innomizer® and Faculty® from Hosokawa Micron Corp., Kryptron® series from Earthtechnica, FM from Nippon Pneumatic MFG.

Further, a commonly available mechanical rotary pulverizer such as an impeller mill, a hammer mill or the like can be used as a mechanical rotary machine used for applying impact compression force. In general, when these pulverizers are used, particles are pulverized, and their particle diameters are significantly changed. However, they can be used for surface modification in a case where a structure is provided in which a liner inside a pulverizer is smoothed so that impact compression force from the liner is reduced. Such a system is preferred because fine unevenness on the surface of a carbon material can be adjusted without changing particle diameters and crystal structures significantly.

In addition, as a mechanical rotary machine used for apply impact compression force, a system (for example, an ACM pulverizer, a Faculty, a Kryptron Eddy and the like) can be used comprising unevenness on the inside of a side where a rotary drum or a rotor is faced with an inner piece or a fixed drum. Such a system is preferred because the surface modification efficiency is high, and the processing time can be shortened.

By using the mechanical rotary machines as described above, only surface modification can be performed without introducing distortion into the crystal structure of a graphite.

The surface modification in the manufacturing method according to the present invention is preferably performed at a ratio of an apparent density after the surface modification to an apparent density before the surface modification of less than 1.1. Note that the apparent density has the same meaning as the aforementioned tap density. Further, the surface modification in the manufacturing method according to the present invention is preferably performed at a ratio of D50 after the surface modification to D50 before the surface modification of not less than 0.9 and less than 1.1.

### (Paste for an Electrode)

The paste for an electrode according to one embodiment of the present invention contains a carbon material according to the present invention, a binder and if desired, a solvent, an electrically conductive assistant and the like. The above paste for an electrode can be obtained, for example, by kneading a carbon material according to the present invention, a binder and if desired, a solvent, an electrically conductive assistant and the like. The paste for an electrode can be shaped into a form such as a sheet and a pellet.

Binders include, for example, polyethylene, polypropylene, ethylene-propylene terpolymer, butadiene rubber, styrene-butadiene rubber, butyl rubber, acrylic rubber, a polymer compound with high ionic conductivity or the like. Examples of the polymer compound with high ionic conductivity include poly(vinylidene fluoride), polyethylene oxide, polyepichlorohydrin, polyphosphazene, polyacrylonitrile and the like. The amount of a binder is preferably 0.5 to 20 parts by mass relative to 100 parts by mass of a carbon material.

There is no particular limitation for the electrically conductive assistants as long as they serve to impart electric conductivity and electrode stability (an buffering action against the volume change due to intercalation/deintercalation of lithium ions) on an electrode. For example, they include a vapor grown carbon fiber (for example, “VGCF®”, Showa Denko K.K.), electrically conductive carbon (for example, “Denka Black” from Denki Kagaku Kogyo K.K., “Super C65” from TIMCAL Graphite & Carbon, “Super C45” from TIMCAL Graphite & Carbon, “KS6L” from TIMCAL Graphite & Carbon) or the like. The amount of an electrically conductive assistant is preferably 10 to 100 parts by mass relative to 100 parts by mass of a carbon material.

There is no particular limitation for solvents used for the paste. Solvents include, for example, N-methyl-2-pyrrolidone, dimethylformamide, isopropanol, water or the like. In the case of a binder for which water is used as a solvent, a thickening agent is preferably used in combination. The amount of a solvent will be adjusted so that the paste shows a viscosity at which application of the paste to a current collector is facilitated.

### (Electrode)

The electrode according to one embodiment of the present invention has a formed layer comprising a carbon material according to the present invention, a binder and if desired, an electrically conductive assistant and the like. A formed layer is usually layered on a current collector.

Current collectors include, for example, a nickel foil, a copper foil, a nickel or copper mesh or the like.

A formed layer comprises at least a binder and the aforementioned carbon material. A formed layer can be obtained, for example, by applying and drying the aforementioned paste for electrodes. There is no particular limitation for methods of applying a paste. A formed layer usually has a thickness of 50 to 200 μm. In a case where the thickness of a formed layer becomes too thick, a negative electrode sheet may not be accommodated in a standard battery housing. The thickness of a formed layer can be adjusted by the application amount of a paste. Further, it can also be adjusted by performing pressure forming after drying a paste. Pressure forming methods include those such as roll pressurization and plate pressurization. A pressure when performing pressure forming is preferably about 100 MPa to about 300 MPa (about 1 to 3 ton/cm²).

In the electrode according to a preferred embodiment of the present invention, the thickness ratio T500/T10 of formed layers is preferably not less than 1.0 and not more than 1.30, more preferably not less than 1.0 and not more than 1.20, even more preferably not less than 1.0 and not more than 1.10. Unless there is a measurement error, a value of T500/T10 will not be less than 1.0, and a larger value of T500/T10 means that the irreversibility of a charge and discharge reaction in a battery is larger. A thickness ratio T500/T10 of formed layers falling within the above range is suitable for obtaining a long-life large battery in which the reversibility of charge and discharge reactions in the battery is high. The thickness ratio T500/T10 of formed layers is computed by the method as described above.

### (Lithium-Ion Secondary Battery)

The lithium ion secondary battery according to one embodiment of the present invention has the electrode (negative electrode) according to the present invention, and in addition, a positive electrode and a nonaqueous electrolyte and/or a nonaqueous polymer electrolyte as components.

As a positive electrode, those conventionally used for lithium ion secondary batteries, specifically, a sheet comprising a positive electrode active material can be used. Examples of positive electrode active materials include LiNiO₂, LiCoO₂, LiMn₂O₄, LiNi_{0.34}Mn_{0.33}Co_{0.33}O₂, LiFePO₄ and the like.

There is no particular limitation for the nonaqueous electrolyte and nonaqueous polymer electrolyte used for lithium ion secondary batteries. They include, for example, organic electrolytic solutions in which a lithium salt such as LiClO₄, LiPF₆, LiAsF₆, LiBF₄, LiSO₃CF₃, CH₃SO₃Li, CF₃SO₃Li or the like is dissolved in a nonaqueous solvent such as ethylene carbonate, diethyl carbonate, dimethyl carbonate, ethylmethyl carbonate, propylene carbonate, butylene carbonate, acetonitrile, propionitrile, dimethoxyethane, tetrahydrofuran, γ-butyrolactone or the like; gel polymer electrolytes comprising polyethylene oxide, polyacrylonitrile, polyvinylidene fluoride, polymethyl methacrylate or the like; and solid polymer electrolytes comprising a polymer having ethylene oxide bonds or the like.

Further, a small amount of a material which undergoes a decomposition reaction when a lithium ion secondary battery is charged for the first time can be added to an electrolytic solution. Such materials include, for example, vinylene carbonate, biphenyl, propanesultone or the like. The addition amount of the material is preferably 0.01 to 5% by mass.

A separator can be provided between a positive electrode and a negative electrode in the lithium ion secondary battery according to the present invention. Separators include, for example, non-woven fabrics, cloths, microporous films comprising polyolefine such as polyethylene, polypropylene or the like as a main component, or combinations thereof.

### EXAMPLES

Examples are shown below to describe the present invention in more detail. Note that these are merely examples for purposes of description, and the present invention shall not in any way be limited to these.

Various properties were measured as follows.

### (Specific Surface Area)

A specific surface area measurement system (NOVA 4200e) from Quantachrome INSTRUMENTS Co. was used to perform heating at 300° C. as preliminary drying and to flow nitrogen gas for 15 minutes, and then measurements were performed by the BET 3-point method with nitrogen gas adsorption.

### (Tap Density)

Using a powder density measurement device “Tap Denser KYT-4000K” from Seishin Enterprise Co., Ltd., a cell was completely filled, and then tapping with a stroke length of 2 mm was performed for 400 times to measure an apparent density at that time.

### (Apparent Density Ratio)

The apparent density ratio before and after treatment refers to a tap density ratio before and after treatment in which a tap density before treatment is the denominator and a tap density after treatment is the numerator.

### (Particle Diameter)

To 10 mg of water, added were a microspatula full of a powder and a nonionic surfactant in an amount to give 0.1%, and ultrasonic dispersion was performed for 5 minutes. This dispersion liquid was introduced into a laser diffraction particle size distribution measurement device (LMS-2000e) from Seishin Enterprise Co., Ltd. to measure number-based and volume-based particle size distributions, and then the 50% particle diameter (D50) was calculated from the volumetric accumulative particle size distribution.

### (Powder X-Ray Diffraction Analysis)

A sample plate with a depth of 0.1 cm was filled with a carbon powder without aligning in a specific orientation, and measurements were performed with an X-ray diffractometer (Rigaku Corporation, Smart Lab) under the following conditions. Diffraction lines were analyzed using an analysis software PDXL from Rigaku Corporation.

Target: Copper

Tube voltage: 40 kV

Tube current: 200 mA

Divergent slit: ½°

Scattering slit: ½°

Receiver slit: 0.15 mm

Operation mode: Continuous

Scan step: 0.02°

Measurement time: 10 seconds

### (Thermogravimetric-Differential Thermal Analysis)

A differential thermal-thermal gravimetric simultaneous measurement system (EXSTAR TG/DTA 6300) from Seiko Instruments Inc. was used to perform measurements on a 2 mg of a sample under an air flow of 200 ml/min at a heating rate of 10° C./min in a range from a room temperature to 1000° C. A temperature at which an exothermic peak appeared was determined on a differential thermal curve.

### (Raman Spectroscopic Analysis)

A laser Raman spectrometer (NRS-5100) from Jasco Corp. was used to perform measurements under the conditions: an excitation wavelength of 532 nm, an entrance slit width of 200 μm, an exposure time of 3 seconds, 2 times of integration and a diffraction grading of 1800 lines/mm. The ratio (I_{D}/I_{G}) of the intensity I_{D} of a peak around 1360 cm⁻¹ (from a noncrystalline component) and the intensity I_{G} of a peak around 1580 cm⁻¹ (from a graphite component) was computed from the measured spectrum. This was taken as an R value to give a measure of the degree of graphitization.

### (Initial Efficiency)

The following operations were performed inside a glove box in which a dry argon gas atmosphere with a dew point of −75° C. or less was maintained.

Model 2032 coin cells (diameter: 20 mm, thickness: 3.2 mm; Hohsen Corp.) were prepared. A negative electrode sheet with a diameter of 15 mm was placed in a coin cell housing. An electrolytic solution was poured into the housing to allow permeation into the negative electrode sheet. A separator with a diameter of 20 mm (Celgard 2400) and a lithium foil with a diameter of 17.5 mm and a thickness of 3 mm were placed thereonto in this order. This was covered with a coin cell cap having a gasket, and the coin cell housing and the coin cell cap were caulked and sealed to obtain a lithium ion secondary battery for evaluation.

Note that the electrolytic solution is a liquid obtained by dissolving an electrolyte LiPF₆ at a concentration of 1 mol/L in a solvent in which ethylene carbonate and ethylmethyl carbonate were mixed in a volume ratio of 2:3.

The lithium ion secondary battery for evaluation was removed from the glove box, and allowed to stand at room temperature for 24 hours. Constant current charge was performed from the rest potential to 4.5 V at 0.2 mA, and subsequently constant voltage charge was performed at 4.5 V until a value of electric current decreased to 0.2 mA. Then, constant current discharge was performed at 0.2 mA, and then cut off at 2.5 V and paused for 10 minutes. A charge capacity and discharge capacity at that time were measured, and the initial efficiency was computed based on the following expression.

Initial efficiency(%)=((discharge capacity)/(charge capacity))×100

### (Manufacture of Laminated Cell for Evaluation)

The following operations were performed inside a glove box in which a dry argon gas atmosphere with a dew point of −80° C. or less was maintained.

N-methylpyrrolidone was appropriately added to 90 parts by mass of a carbon material, 2 parts by mass of an electrically conductive assistant (C45; TIMCAL Graphite & Carbon), 3 parts by mass of an electrically conductive assistant (KS6L) and 5 parts (as a solid content) by mass of polyvinylidene fluoride (KF polymer W#1300; Kureha Corporation) with stirring and mixing to prepare a slurry-like dispersion liquid. The resulting dispersion liquid was applied on a 20-μm thick copper foil with a doctor blade having a clearance of 200 μm, and dried. Then pressure forming was performed to obtain a negative electrode sheet.

N-methylpyrrolidone was appropriately added to 90 parts by mass of LiMO₂ (M=Ni, Mn, Co; a ternary positive electrode material from Unicore), 2 parts by mass of an electrically conductive assistant (C45; TIMCAL Graphite & Carbon), 3 parts by mass of an electrically conductive assistant (KS6L) and 5 parts (as a solid content) by mass of polyvinylidene fluoride (KF polymer W#1300; Kureha Corporation) with stirring and mixing to prepare a slurry-like dispersion liquid. The resulting dispersion liquid was applied on a 20-μm thick aluminum foil with a doctor blade having a clearance of 200 μm, and dried. Then pressure forming was performed to obtain a positive electrode sheet.

The negative electrode sheet and the positive electrode sheet were stacked with a polypropylene separator (Celgard 2400; Tonen Corp.) between them. This was placed into an aluminum laminated packaging material, and an electrolytic solution was injected. Then it was heat sealed under vacuum to obtain a laminated cell for evaluation.

The electrolytic solution is a liquid obtained by dissolving an electrolyte LiPF₆ at a concentration of 1 mol/L in a solvent in which ethylene carbonate, diethyl carbonate and ethylmethyl carbonate were mixed in a volume ratio of 3:2:5.

### (500-Cycle Capacity Retention Ratio [Cycle Characteristics])

Charge and discharge were performed under the following conditions using the laminated cell for evaluation.

The first and second charge and discharge cycles were performed as follows. Constant current charge was performed at 5.5 mA from the rest potential to 4.2 V, and then constant voltage charge was performed at 4.2 V, and charge was stopped at the time when a value of electric current decreased to 0.27 mA. Subsequently, constant current discharge was performed at 5.5 mA, and then cut off at a voltage of 2.7 V.

Charge and discharge cycles from the third time and on were performed as follows. Constant current charge was performed at 11 mA (equivalent to 2 C) from the rest potential to 4.2 V, and then constant voltage charge was performed at 4.2 V, and charge was stopped at the time when a value of electric current decreased to 55 pA. Subsequently, constant current discharge was performed at 1.65 mA (equivalent to 3 C), and cut off at a voltage of 2.7 V.

Then, the ratio (500-cycle capacity maintenance ratio) of the 500th discharge capacity to the third discharge capacity was computed. This capacity retention ratio indicates cycle characteristics in high current charge and discharge.

(Change Ratio in Electrode Thickness after Measurement of 500-Cycle Discharge Capacity (T500/T10))

By the same method as that of producing a laminated cell used for measurements of cycle characteristics, two or more laminated cells for evaluation with the same specification were produced. With a laminated cell for evaluation, 10 cycles of charge and discharge were performed at 1 C. At the end of discharge in the 10th cycle, the thickness (T10) of a formed layer on a negative electrode sheet was measured. With a laminated cell for evaluation, 500 cycles of charge and discharge were performed at 1 C. At the end of discharge in the 500th cycle, the thickness (T500) of a formed layer on a negative electrode sheet was measured. Then the thickness ratio (T500/T10) of formed layers was computed.

### (50° C. Capacity Retention Ratio)

By the same method as that of producing a laminated cell used for measurements of cycle characteristics, laminated cells were produced.

Constant current charge was performed at 0.5 C from the rest potential to 4.2 V at 5.5 mA, and then constant voltage charge was performed at 4.2 V, and charge was stopped at the time when a value of electric current decreased to 0.27 mA. Subsequently, constant current discharge was performed at 5.5 mA, and then cut off at a voltage of 2.75 V. This operation was repeated for 10 times. The discharge capacity Q1 at the time of the 10th operation was measured.

Next, after performing full charge to 4.2 V and masking an electrode tab to prevent short-circuit, the cell was allowed to stand in a thermostatic oven at 50° C. for 4 weeks. The cell was removed from the thermostatic oven and charged to 2.75 V at 0.5 C, and then discharged. The discharge capacity Q2 at this time was measured.

The 50° C. capacity retention ratio was defined as Q2/Q1×100 [%].

### (Direct Current Resistance (DCR))

By the same method as that of producing a laminated cell used for measurements of cycle characteristics, laminated cells were produced.

First, constant current discharge was performed at 5.5 mA. Then constant current charge was performed at 5.5 mA from the rest potential to 4.2 V, and then constant voltage charge was performed at 4.2 V from the point at which 4.2 V was reached, and charge was stopped at the time when a value of electric current decreased to 0.27 mA. Subsequently, constant current discharge was performed at 0.55 mA (equivalent to 0.1 C) for 2 hours.

Constant current discharge was performed at 1.1 mA (equivalent to 0.2 C) for 5 seconds, and paused for 30 minutes. Subsequently, constant current charge at 0.11 mA (equivalent to 0.02 C) and constant voltage charge at 4.2 V from the point at which 4.2 V was reached were performed for 50 seconds in total. The electric currents and voltages at that time were recorded.

This constant current discharge for 5 seconds, and constant current charge and constant voltage charge for 50 seconds were performed at each of 0.2 C, 0.5 C, 1 C and 2 C. Then the electric currents and voltages at these times were recorded.

Constant current discharges were performed at 0.55 mA (equivalent to 0.1 C) from full charge each for 3.5 hours, 5 hours, 6.5 hours and 8 hours. The electric currents and voltages at these times were recorded. Similarly, constant current discharges equivalent to 0.2 C, 0.5 C, 1 C and 2 C were performed for 3.5 hours, 5 hours, 6.5 hours and 8 hours, respectively. The electric currents and voltages at these times were recorded.

“Direct-current resistance” was computed from the values of the recorded electric currents and voltages.

### Example 1

A heavy fraction was removed from the crude oil from Liao ning sheng, China (API28, wax content: 17%, sulfur content: 0.66%) by atmospheric distillation. Fluid bed catalytic cracking of the heavy fraction was performed at 510° C. under normal pressure using a sufficient amount of a Y type zeolite catalyst. Solid contents such as catalyst were removed from the decomposition product by centrifugation to obtain a transparent decant oil 1. This oil was introduced into a small delayed coking process. Coking was performed for 10 hours at a drum inlet temperature of 505° C. and a drum internal pressure of 600 kPa (6 kgf/cm²). Then, it was water-cooled to obtain a black mass (a raw coke).

The black mass obtained was hammer-pulverized so that the maximum size became about 5 cm. The feed of the black mass and the inclination angle of a rotary kiln were adjusted so that the residence time of the pulverized black mass was 15 minutes in the kiln (an external heating type with an electric heater, an aluminum oxide SSA-ST 120-mm inner cylinder) in which an outer wall temperature at the center of the inner cylinder was set to 1450° C., and the black mass was then heated. The red hot mass obtained was placed into a stainless steel container to block the outside air, and cooled by external water cooling while flowing a required amount of nitrogen gas such that negative pressure was not created inside the container. A calcined coke 1 was obtained which was somewhat grayish black, and has a size of up to about 2 cm.

The calcined coke 1 was pulverized with a Bantam mill from Hosokawa Micron Corp., and then coarse powder was removed using a sieve with 32-μm openings. Next, air classification was performed with a Turbo Classifier TC-15N from Nissin Engineering, Inc. to remove particles with a particle diameter of 1.0 μm or less.

A graphite crucible was filled with the calcined coke 1 subjected to the particle size adjustment, and placed into an Acheson furnace in a state where a carbonized carbon felt (2 mm) was placed on the crucible so that air would not rapidly flow in. Heat treatment was then performed at 3150° C. to obtain a graphite powder 1 with a D50 of 22.6 μm.

Surface modification treatment was performed on the graphite powder 1 using an ACM pulverizer from Hosokawa Micron Corp. under the conditions: a pulverizing rotor peripheral velocity of 90 m/s, a classification rotor peripheral velocity of 100 m/s, an air flow of 15 m³/min, a mean residence time of 1 minute and a powder throughput per batch of 2 kg. The surface modification treatment resulted in a D50 of 23.4 μm. Then, coarse powder was removed using a sieve with 32-μm openings to obtain a carbon material with a D50 of 22.6 μm.

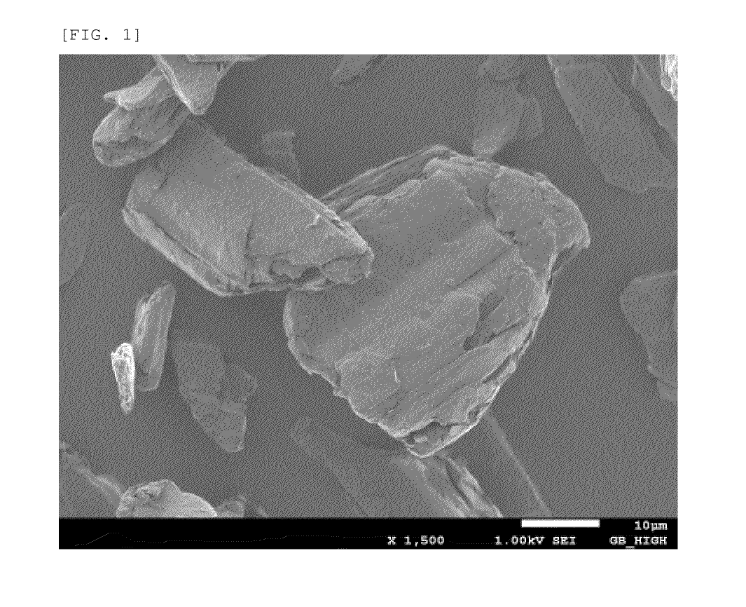

Various physical properties were measured for the carbon material obtained, and then an electrode was produced, and charge and discharge characteristics were measured. Results are shown in Table 2, Table 3 and FIG. 1.

### Example 2

Surface modification treatment was performed by the same method as in Example 1 except that the pulverizing rotor peripheral velocity was changed to 125 m/s. The surface modification treatment resulted in a D50 of 22.9 μm. Then, coarse powder was removed using a sieve with 32-μm openings to obtain a carbon material with a D50 of 21.0 μm.

Various physical properties were measured for the carbon material obtained, and then an electrode was produced, and charge and discharge characteristics were measured. Results are shown in Table 2 and Table 3.

### Example 3

Surface modification treatment was performed by the same method as in Example 1 except that the pulverizing rotor peripheral velocity was changed to 125 m/s and the treatment time was changed to 3 minutes. The surface modification treatment resulted in a D50 of 22.1 μm. Then, coarse powder was removed using a sieve with 32-μm openings to obtain a carbon material with a D50 of 20.6 μm.

Various physical properties were measured for the carbon material obtained, and then an electrode was produced, and charge and discharge characteristics were measured. Results are shown in Table 2 and Table 3.

### Example 4

The graphite powder 1 was processed using a mechanical rotary composing machine (Showa Denko K. K.) having impellers in a rotary part under the conditions: a pulverizing rotor peripheral velocity of 25 m/s, a treatment time of 30 minutes and a throughput per batch of 4 kg. Then, coarse powder was removed using a sieve with 32-μm openings. Next, air classification was performed with a Turbo Classifier TC-15N from Nissin Engineering, Inc. to obtain a carbon material with a D50 of 22.1 μm which did not substantially comprise particles with a particle diameter of 1.0 μm or less.

Various physical properties were measured for the carbon material obtained, and then an electrode was produced, and charge and discharge characteristics were measured. Results are shown in Table 2 and Table 3.

### Comparative Example 1

A carbon material was produced in which surface modification treatment was not performed on the graphite powder 1, and coarse powder was removed using a sieve with 32-μm openings.

Various physical properties were measured for the carbon material obtained, and then an electrode was produced, and charge and discharge characteristics were measured. Results are shown in Table 2 and Table 3.

### Comparative Example 2

The graphite powder 1 was pulverized using a jet mill. The D50 of the pulverized powder was 12.0 μm. Using an ACM pulverizer from Hosokawa Micron Corp., 2 kg of the pulverized powder was processed under the conditions: a pulverizing rotor peripheral velocity of 90 m/s, a classification rotor peripheral velocity of 100 m/s, an air flow of 15 m³/min, a mean residence time of 1 minute and a throughput per batch of 2 kg. This treatment resulted in a D50 of 11.5 μm. Then, coarse powder was removed using a sieve with 32-μm openings to obtain a carbon material with a D50 of 11.4 μm.

Various physical properties were measured for the carbon material obtained, and then an electrode was produced, and charge and discharge characteristics were measured. Results are shown in Table 2 and Table 3.

### Comparative Example 3

Stirring treatment was performed on 0.1 g of the graphite powder 1 with a ball mill for 1 hour. This treatment resulted in a D50 of 12.0 μm. Then, coarse powder was removed using a sieve with 32-μm openings to obtain a carbon material with a D50 of 11.8 μm.

Various physical properties were measured for the carbon material obtained, and then an electrode was produced, and charge and discharge characteristics were measured. Results are shown in Table 2 and Table 3.

### Comparative Example 4

Surface modification treatment was performed by the same method as in Example 1 except that the pulverizing rotor peripheral velocity was changed to 160 m/s, and the mean residence time was changed to 10 minutes. The surface modification treatment resulted in a D50 of 18.3 μm. Then, coarse powder was removed using a sieve with 32-μm openings to obtain a carbon material with a D50 of 18.1 μm.

Various physical properties were measured for the carbon material obtained, and then an electrode was produced, and charge and discharge characteristics were measured. Results are shown in Table 2 and Table 3.

### Comparative Example 5

Surface modification treatment was performed on the calcined coke 1 using an ACM pulverizer from Hosokawa Micron Corp. under the conditions: a pulverizing rotor peripheral velocity of 90 m/s, a classification rotor peripheral velocity of 100 m/s, an air flow of 15 m³/min, a mean residence time of 1 minute and a powder throughput per batch of 2 kg to obtain a coke with a D50 of 21.0 μm.

A graphite crucible was filled with the coke obtained, and placed into an Acheson furnace in a state where a carbonized carbon felt (2 mm) was placed on the crucible so that air would not rapidly flow in. Heat treatment was then performed at 3150° C. to obtain a graphite powder. Then, coarse powder was removed using a sieve with 32-μm openings to obtain a carbon material with a D50 of 21.0 μm.

Various physical properties were measured for the carbon material obtained, and then an electrode was produced, and charge and discharge characteristics were measured. Results are shown in Table 2 and Table 3.

### Comparative Example 6

To 100 parts by mass of the graphite powder 1, added was 5 parts by mass of a powdered isotropic coal pitch with a D50 of 3.1 μm which did not substantially comprise particles 20 μm or more (Softening point: 130° C., Actual carbon ratio: 60%). Then dry mixing was performed for 20 minutes at 2000 rpm using a rotation and revolution type mixer with a throughput per batch of 4 kg to obtain a mixture.

The mixture was heated for 1 hour at 1100° C. under an argon atmosphere, and a carbon material with a D50 of 23.5 μm was obtained using a sieve of 32-μm openings.

Various physical properties were measured for the carbon material obtained, and then an electrode was produced, and charge and discharge characteristics were measured. Results are shown in Table 2 and Table 3.

### Example 5

The residue obtained by vacuum distilling the crude oil from U.S. West Coast was prepared as a raw material. The above raw material has an API of 18, a wax content of 11% by mass and a sulfur content of 3.5% by mass. This raw material was introduced into a small delayed coking process. Coking was performed for 10 hours at a drum inlet temperature of 490° C. and a drum internal pressure of 2 kgf/cm². Then, it was water cooled to obtain a black mass.

The black mass obtained was hammer-pulverized so that the maximum size became about 5 cm. The feed of the black mass and the inclination angle of a rotary kiln were adjusted so that the residence time of the pulverized black mass was 15 minutes in the kiln (an external heating type with an electric heater, an aluminum oxide SSA-ST 120-mm inner cylinder) in which an outer wall temperature at the center of the cylinder was set to 1450° C., and the black mass was then heated. The red hot mass obtained was placed into a stainless steel container to block the outside air, and cooled by external water cooling while flowing a required amount of nitrogen gas such that negative pressure was not created inside the container. A calcined coke 2 having a size of up to about 3 cm was obtained.

The calcined coke 2 was pulverized with a Bantam mill from Hosokawa Micron Corp., and coarse powder was then removed using a sieve with 45-μm openings. Next, air classification was performed with a Turbo Classifier TC-15N from Nissin Engineering, Inc. to remove particles with a particle diameter of 1.0 μm or less. A graphite crucible was filled with the calcined coke 2 subjected to classification, and placed into an Acheson furnace in a state where a carbonized carbon felt (2 mm) was placed on the crucible so that air would not rapidly flow in. Heat treatment was then performed at 3150° C. to obtain a graphite powder 2 with a D50 of 16.8 μm.

Surface modification treatment was performed on the graphite powder 2 using an ACM pulverizer from Hosokawa Micron Corp. under the conditions: a pulverizing rotor peripheral velocity of 90 m/s, a classification rotor peripheral velocity of 100 m/s, an air flow of 15 m³/min, a mean residence time of 1 minute and a powder throughput per batch of 2 kg. D50 was 16.5 μm. Then, coarse powder was removed using a sieve with 45-μm openings to prepare a carbon material with a D50 of 16.2 μm.

Various physical properties were measured for the carbon material obtained, and then an electrode was produced, and charge and discharge characteristics were measured. Results are shown in Table 2 and Table 3.

### Example 6

Surface modification treatment was performed by the same method as in Example 5 except that a pulverizing rotor peripheral velocity was changed to 160 m/s, and the mean residence time was changed to 3 minutes. D50 was 16.0 μm. Then, coarse powder was removed using a sieve with 45-μm openings to obtain a carbon material with a D50 of 15.9 μm.

Various physical properties were measured for the carbon material obtained, and then an electrode was produced, and charge and discharge characteristics were measured. Results are shown in Table 2 and Table 3.

### Example 7

Surface modification treatment of a carbon material was performed by the same method as in Example 4 except that the graphite powder 2 was used. D50 was 16.6 μm. Then, coarse powder was removed using a sieve with 45-μm openings to obtain a carbon material with a D50 of 15.9 μm.

Various physical properties were measured for the carbon material obtained, and then an electrode was produced, and charge and discharge characteristics were measured. Results are shown in Table 2 and Table 3.

### Example 8

The calcined coke 1 was pulverized with a Bantam mill from Hosokawa Micron Corp., and then coarse powder was removed using a sieve with 32-μm openings. Next, air classification was performed with a turbo classifier TC-15N from Nissin Engineering, Inc. to remove particles with a particle diameter of 1.0 μm or less. A graphite crucible was filled with the calcined coke 1 subjected to the particle diameter adjustment. It was placed into an Acheson furnace without covering the crucible to allow contact with sufficient air during graphitization at 3150° C. and during cooling. Top 25 cm of the graphite produced in the crucible was removed, and a portion under it was taken out to obtain a graphite powder 3 with a D50 of 22.6 μm.

Surface modification treatment of a carbon material was performed by the same method as in Example 1 except that the graphite powder 3 was used. D50 was 22.8 μm. Then, coarse powder was removed using a sieve with 32-μm openings to obtain a carbon material with a D50 of 21.4 μm.

Various physical properties were measured for the carbon material obtained, and then an electrode was produced, and charge and discharge characteristics were measured. Results are shown in Table 2 and Table 3.

### Comparative Example 7

Without performing surface modification treatment on the graphite powder 2, coarse powder was removed using a sieve with 45-μm openings obtain a carbon material with a D50 of 16.0 μm.

Various physical properties were measured for the carbon material obtained, and then an electrode was produced, and charge and discharge characteristics were measured. Results are shown in Table 2 and Table 3.

### Comparative Example 8

A carbon material was processed by the same method as in Comparative Example 3 except that the graphite powder 2 was used. This treatment resulted in a D50 of 13.2 μm. Then, coarse powder was removed using a sieve with 45-μm openings to obtain a carbon material with a D50 of 13.1 μm.

Various physical properties were measured for the carbon material obtained, and then an electrode was produced, and charge and discharge characteristics were measured. Results are shown in Table 2 and Table 3.

The main processing conditions in Examples 1 to 8 and Comparative Examples 1 to 8 were together described in Table 1.

TABLE 1

| | | Surface | | | | Surface | | | |
|---|---|---|---|---|---|---|---|---|---|
| | | modification | | | | modification | | | Coating |
| | | treatment before | | | Pulverization | treatment after | | | calcination |
| | | graphitization | | | after | graphitization | | | after |
| | Graphite | m/s | min | kg | graphitization | m/s | min | kg | graphitization |
| Ex. 1 | 1 | — | — | — | — | 90 | 1 | 2 | — |
| Ex. 2 | 1 | — | — | — | — | 125 | 1 | 2 | — |
| Ex. 3 | 1 | — | — | — | — | 125 | 3 | 2 | — |
| Ex. 4 | 1 | — | — | — | — | 25 | 30 | 4 | — |
| Comp. Ex. 1 | 1 | — | — | — | — | — | — | — | — |
| Comp. Ex. 2 | 1 | — | — | — | Yes | 90 | 1 | 2 | — |
| Comp. Ex. 3 | 1 | — | — | — | — | — | 60 | 0.1 | — |
| Comp. Ex. 4 | 1 | — | — | — | — | 160 | 10 | 2 | — |
| Comp. Ex. 5 | 1 | 90 | 1 | 2 | — | — | — | — | — |
| Comp. Ex. 6 | 1 | — | — | — | — | — | — | — | Yes |
| Ex. 5 | 2 | — | — | — | — | 90 | 1 | 2 | — |
| Ex. 6 | 2 | — | — | — | — | 160 | 3 | 2 | — |
| Ex. 7 | 2 | — | — | — | — | 25 | 30 | 4 | — |
| Ex. 8 | 3 | — | — | — | — | 90 | 1 | 2 | — |
| Comp. Ex. 7 | 2 | — | — | — | — | — | — | — | — |
| Comp. Ex. 8 | 2 | — | — | — | — | — | 60 | 0.1 | — |

TABLE 2

| | | | | | Apparent | | XRD | | Number |
|---|---|---|---|---|---|---|---|---|---|
| | | | D50 after | | density after | | peak | | of |
| | | | treatment/ | | treatment/ | | at | | TG-DCA |
| | | D50 after | D50 | Tap | apparent | | 42.7° | | peaks at |
| | BET | treatment | before | density | density before | R | to | d₀₀₂ | 500 to |
| | m²/g | μm | treatment | g/cm³ | treatment | value | 43.7° | nm | 1000° C. |
| Ex. 1 | 1.8 | 23.4 | 1.04 | 0.89 | 1.01 | 0.13 | None | 0.3356 | 1 |
| Ex. 2 | 2.7 | 22.9 | 1.01 | 0.92 | 1.05 | 0.14 | None | 0.3356 | 1 |
| Ex. 3 | 3.7 | 22.1 | 0.98 | 0.94 | 1.07 | 0.23 | None | 0.3356 | 1 |
| Ex. 4 | 1.7 | 22.1 | 0.98 | 0.92 | 1.05 | 0.30 | None | 0.3356 | 1 |
| Comp. Ex. 1 | 1.1 | — | — | 0.88 | — | 0.08 | None | 0.3356 | 1 |
| Comp. Ex. 2 | 7.5 | 11.5 | 0.96 | 1.12 | — | 0.31 | Yes | 0.3356 | 1 |
| Comp. Ex. 3 | 9.2 | 11.8 | 0.52 | 1.35 | 1.53 | 0.49 | Yes | 0.3356 | 1 |
| Comp. Ex. 4 | 8.8 | 18.3 | 0.81 | 1.00 | 1.14 | 0.45 | None | 0.3356 | 1 |
| Comp. Ex. 5 | 1.0 | 21.0 | 0.93 | 0.88 | 1.00 | 0.06 | None | 0.3356 | 1 |
| Comp. Ex. 6 | 0.9 | — | — | 0.86 | — | 0.45 | None | 0.3357 | 2 |
| Ex. 5 | 2.5 | 16.5 | 0.98 | 1.18 | 0.94 | 0.12 | None | 0.3360 | 1 |
| Ex. 6 | 4.9 | 16.0 | 0.95 | 1.23 | 0.98 | 0.24 | None | 0.3360 | 1 |
| Ex. 7 | 2.4 | 16.6 | 0.99 | 1.20 | 0.95 | 0.15 | None | 0.3360 | 1 |
| Ex. 8 | 2.3 | 22.8 | 1.01 | 0.91 | 1.01 | 0.15 | None | 0.3356 | 1 |
| Comp. Ex. 7 | 2.3 | — | — | 1.26 | — | 0.06 | None | 0.3360 | 1 |
| Comp. Ex. 8 | 6.8 | 13.2 | 0.79 | 1.40 | 1.11 | 0.42 | Yes | 0.3360 | 1 |

TABLE 3

| | | | | | 500- | |
|---|---|---|---|---|---|---|
| | | | | 50° C. | cycle | |
| | | | | capacity | capacity | |
| | Initial | Discharge | DCR | retention | retention | |
| | efficiency | capacity | (SOC50%) | ratio | ratio | T500/ |
| | % | mAh/g | Ω | % | % | T10 |
| Ex. 1 | 90 | 345 | 1.4 | 71 | 83 | 1.08 |
| Ex. 2 | 92 | 345 | 1.3 | 70 | 82 | 1.07 |
| Ex. 3 | 89 | 345 | 1.3 | 70 | 80 | 1.07 |
| Ex. 4 | 88 | 345 | 1.4 | 71 | 81 | 1.08 |
| Comp. Ex. 1 | 67 | 310 | 1.7 | 70 | 65 | 1.54 |
| Comp. Ex. 2 | 82 | 330 | 1.3 | 69 | 75 | 1.44 |
| Comp. Ex. 3 | 70 | 310 | 1.4 | 62 | 60 | 1.65 |
| Comp. Ex. 4 | 78 | 330 | 1.3 | 68 | 75 | 1.38 |
| Comp. Ex. 5 | 75 | 310 | 1.8 | 71 | 69 | 1.49 |
| Comp. Ex. 6 | 85 | 345 | 1.4 | 65 | 75 | 1.40 |
| Ex. 5 | 92 | 330 | 3.6 | 90 | 87 | 1.06 |
| Ex. 6 | 91 | 330 | 3.5 | 90 | 87 | 1.07 |
| Ex. 7 | 92 | 330 | 3.6 | 90 | 87 | 1.06 |
| Ex. 8 | 92 | 345 | 1.3 | 71 | 84 | 1.07 |
| Comp. Ex. 7 | 88 | 330 | 4.1 | 90 | 87 | 1.09 |
| Comp. Ex. 8 | 83 | 325 | 3.7 | 85 | 82 | 1.08 |

1.-12. (canceled)

13. A carbon material for negative electrode in lithium ion secondary battery, wherein
the carbon material has a specific surface area of not less than 1.5 m²/g and not more than 6.5 m²/g, a tap density of not less than 0.5 g/cm³ and not more than 1.3 g/cm³, a Raman R value of not less than 0.1 and not more than 0.4, and d₀₀₂ of not more than 0.337 nm, in which no diffraction peak is present in a range of diffraction angle of 42.7° to 43.7° in X-ray diffraction analysis of the carbon material, and at most one peak is present in a range of not less than 500° C. and less than 1000° C. in thermogravimetric-differential thermal analysis of the carbon material.

14. The carbon material according to claim 13, which has a 50% particle diameter (D50) in a volumetric cumulative particle size distribution by the laser diffraction method of not less than 1 μm and not more than 50 μm.

15. The carbon material according to claim 13, which provides a battery comprising a negative electrode, in which the negative electrode comprises a formed layer, wherein the ratio T500/T10 of the thickness T500 of the formed layer at the end of discharge in the 500th cycle when and if the battery is subjected to 500 cycles of charge-discharge at 1 C to the thickness T10 of the formed layer at the end of discharge in the 10th cycle is not less than 1.0 and not more than 1.30, when and if the battery is subjected to 10 cycles of charge-discharge at 1 C.

16. A method for manufacturing the carbon material according to claim 13, the method comprising applying impact compression force to a granular graphite using a mechanical rotary machine to perform surface modification.

17. The method for manufacturing the carbon material according to claim 16, wherein the ratio of an apparent density after performing the surface modification to an apparent density before performing the surface modification is less than 1.1.

18. The method for manufacturing the carbon material according to claim 16, wherein the granular graphite is an artificial graphite subjected to heat treatment at a temperature of not less than 2400° C. and not more than 3600° C.

19. The method for manufacturing the carbon material according to claim 16, wherein the granular graphite is an artificial graphite synthesized from coke or pitch.

20. The method of manufacturing the carbon material according to claim 16, wherein the granular graphite is an artificial graphite synthesized by heat treating particles obtained by pulverizing calcined coke.

21. A paste for electrode, wherein the paste comprises the carbon material according to claim 13 and a binder.

22. An electrode comprising a formed layer, wherein the formed layer comprises the carbon material according to claim 13 and a binder.

23. A battery comprising the electrode according to claim 22.

24. An electrode comprising a formed layer, wherein a ratio T500/T10 of the thickness T500 of the formed layer at the end of discharge in the 500th cycle to the thickness T10 of the formed layer at the end of discharge in the 10th cycle is not less than 1.0 and not more than 1.30, when and if a battery comprising the electrode is subjected to 500 cycles of charge-discharge at 1 C.

25. A battery comprising the electrode according to claim 24.

26. An electrode comprising a formed layer, wherein the formed layer comprises the carbon material according to claim 14 and a binder.

27. A battery comprising the electrode according to claim 26.

28. An electrode comprising a formed layer, wherein the formed layer comprises the carbon material according to claim 15 and a binder.

29. A battery comprising the electrode according to claim 28.

30. A paste for electrode, wherein the paste comprises the carbon material according to claim 14 and a binder.

31. A paste for electrode, wherein the paste comprises the carbon material according to claim 15 and a binder.
